(19) United States
(12) Patent Application Publication
(10) Pub. No.: US 2023/0176379 A1
(43) Pub. Date: Jun. 8, 2023

(54) LIGHTGUIDE WITH EYE-FOLLOWING OUT-COUPLER

(71) Applicant: Facebook Technologies, LLC, Menlo Park, CA (US)

(72) Inventors: Babak Amirsolaimani, Redmond, WA (US); Renate Eva Klementine Landig, Seattle, WA (US); Andrew Maimone, Duvall, WA (US); Giuseppe Calafiore, Redmond, WA (US)

(21) Appl. No.: 17/688,649

(22) Filed: Mar. 7, 2022

Related U.S. Application Data
(60) Provisional application No. 63/286,349, filed on Dec. 6, 2021.
(60) Provisional application No. 63/286,230, filed on Dec. 6, 2021.

(51) Int. Cl. G02B 27/01; G02F 1/133

(52) U.S. Cl. CPC G02B 27/0172; G02B 27/0179; G02F 1/13306; G02B 2027/014; G02B 2027/0187; G02B 6/0013

(57) ABSTRACT

A display apparatus includes a lightguide for conveying images to a viewing area in a target field-of-view (FOV), and an eye detector for detecting a position of an eye in the viewing area. The lightguide includes a tunable segmented output diffraction grating, each segment for diffracting a portion of the image light to a corresponding segment of the viewing area. A controller is configured to switch to a non-diffracting state those of the segments that are located outside of the target FOV when viewed from the detected eye position.

### REFERENCE TO RELATED APPLICATIONS

This application claims priority from U.S. Provisional Patent Application No. 63/286,349 entitled “Active Gratings in Pupil-Replicated Displays and Illuminators”, and U.S. Provisional Patent Application No. 63/286,230 entitled “Active Fluidic Optical Element”, both filed on Dec. 6, 2021 and incorporated herein by reference in their entireties.

### TECHNICAL FIELD

The present disclosure relates visual display devices and related components, modules, and methods.

### BACKGROUND

Visual displays provide information to viewer(s) including still images, video, data, etc. Visual displays have applications in diverse fields including entertainment, education, engineering, science, professional training, advertising, to name just a few examples. Some visual displays such as TV sets display images to several users, and some visual display systems such as near-eye displays (NEDs) are intended for individual users.

An artificial reality system generally includes an NED (e.g., a headset or a pair of glasses) configured to present content to a user. The near-eye display may display virtual objects or combine images of real objects with virtual objects, as in virtual reality (VR), augmented reality (AR), or mixed reality (MR) applications. For example, in an AR system, a user may view images of virtual objects (e.g., computer-generated images (CGIs)) superimposed with the surrounding environment by seeing through a “combiner” component. The combiner of a wearable display is typically transparent to external light but includes some light routing optic to direct the display light into the user's field of view.

Because a display of HMD or NED is usually worn on the head of a user, a large, bulky, unbalanced, and/or heavy display device with a heavy battery would be cumbersome and uncomfortable for the user to wear. Consequently, head-mounted display devices can benefit from a compact and efficient configuration, including efficient light sources and illuminators providing illumination of a display panel, high-throughput combiner components, ocular lenses, and other optical elements in the image forming train.

### BRIEF DESCRIPTION OF THE DRAWINGS

Exemplary embodiments will now be described in conjunction with the drawings, which are not to scale, in which like elements are indicated with like reference numerals, and in which:

FIG. 1A is a schematic side cross-sectional view of a display apparatus including a pupil replicating lightguide having a segmented output diffraction grating adaptive to eye position;

FIG. 1B is a schematic side cross-sectional view of the display apparatus of FIG. 1 with de-activated segments of the output diffraction grating outside of an image FOV for a first eye position within the eyebox;

FIG. 1C is a schematic side cross-sectional view of the display apparatus of FIG. 1 with de-activated segments of the output diffraction grating outside of an image FOV for a second eye position within the eyebox;

FIG. 1D is a schematic side cross-sectional view of the display apparatus of FIG. 1 with de-activated segments of the output diffraction grating outside of an image FOV for a third eye position within the eyebox;

FIG. 2 is a schematic plan view of an output region of a pupil-replicating lightguide, with an eyebox overlapped, showing portions of an output diffraction grating that out-couple image light to two opposite corners of the eyebox;

FIG. 3A is a schematic plan view of a pupil-replicating lightguide including a segmented output diffraction grating with independently switchable grating segments;

FIG. 3B is a schematic plan view of the pupil-replicating lightguide of FIG. 3A having a first set of segments deactivated for conveying an image to an eye located in first corner area of the eyebox;

FIG. 3C is a schematic top view of the pupil-replicating lightguide of FIG. 3A having a second set of segments deactivated for conveying an image to an eye located in a second corner area of the eyebox opposite the first corner area;

FIG. 4 is a schematic plan view of a pupil-replicating lightguide including a segmented folding grating;

FIG. 5 is a schematic side cross-sectional view of a lightguide with an electrically controllable diffraction grating;

FIG. 6 is a partial plan view of a segmented electrode of a switchable output diffraction grating;

FIG. 7 is a schematic diagram illustrating the operation of a switchable LC surface relief grating;

FIG. 8A is a schematic side cross-sectional diagram of a fluidic grating in a non-diffracting (OFF) state in the absence of electrical field;

FIG. 8B is a schematic side cross-sectional diagram of the fluidic grating of FIG. 8A in a diffracting (ON) state in the presence of spatially-modulated electrical field;

FIG. 9 is a flowchart of a method for displaying images using a switchable lightguide adaptive to an eye position;

FIG. 10 is a view of an augmented reality (AR) display of this disclosure having a form factor of a pair of eyeglasses; and

FIG. 11 is a three-dimensional view of a head-mounted display (HMD) of this disclosure.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art. All statements herein reciting principles, aspects, and embodiments of this disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

As used herein, the terms “first”, “second”, and so forth are not intended to imply sequential ordering, but rather are intended to distinguish one element from another, unless explicitly stated. Similarly, sequential ordering of method steps does not imply a sequential order of their execution, unless explicitly stated.

AR and VR displays may use pupil-replicating lightguides to carry images to an eyebox and/or to illuminate display panels that generate images to be displayed. Herein the term “eyebox” means a geometrical area for the user's eye where a good-quality image may be observed by a user of the NED. A pupil-replicating lightguide may include grating structures for in-coupling a light beam into the lightguide, and/or for out-coupling portions of the light beam along the waveguide surface. In accordance with this disclosure, a grating structure of a pupil-replicating lightguide may include a tunable/switchable grating with switchable or tunable diffraction efficiency, grating pitch or grating period, blazing angle, etc. The terms “grating pitch” and “grating period” are used herein interchangeably. The term “tunable” encompasses both continuously tunable and switchable between two or more states. The term “diffraction efficiency” refers to aspects of the performance of the diffraction grating in terms of power throughput of the diffraction grating. In particular, the diffraction efficiency can be a measure of the optical power diffracted into a given direction compared to the power incident onto the diffractive element. In examples described herein, the diffraction efficiency is typically a measure of the optical power diffracted by the grating or a segment thereof in the first order of diffraction relative to the power incident onto the grating or the segment thereof. The term “output efficiency” as used herein refers to a fraction of the optical power of a light source of a display apparatus that is available to the user for viewing images.

An aspect of the present disclosure relates to a display system comprising a pupil replicating lightguide configured to convey images to a viewing area (“eyebox”). The lightguide is configured to receive image light emitted by an image light source and to convey the image light to the eyebox for presenting to a user in an angular domain within a field-of-view (FOV) of the display. The term “field of view” (FOV), when used in relation to a display system, may refer to an angular range of light propagation supported by the system or visible to the user. A two-dimensional (2D) FOV may be defined by angular ranges in two orthogonal planes. For example, a 2D FOV of a NED device may be defined by two one-dimensional (1D) FOVs, which may be a vertical FOV, for example +\−20° relative to a horizontal plane, and a horizontal FOV, for example +\−30° relative to the vertical plane. With respect to a FOV of a NED, the “vertical” and “horizontal” planes or directions may be defined relative to the head of a standing person wearing the NED. Otherwise the terms “vertical” and “horizontal” may be used in the present disclosure with reference to two orthogonal planes of an optical system or device being described, without implying any particular relationship to the environment in which the optical system or device is used, or any particular orientation thereof to the environment. The term “eyebox” refers to a viewing area, i.e. a spatial region, where a user's eye may be located for a satisfactory image quality, typically near an output region of the lightguide for embodiments described herein. In the context of this specification, the terms “viewing area” and “eyebox” are used interchangeably.

Embodiments described herein relate to a pupil replicating lightguide operable to convey an image to a viewer (“user”) in a manner adaptive to the position of a viewer's eye within an eyebox of the display system. Such eye-adaptive lightguides may include segmented output diffraction gratings with individual segments switchable between a diffracting state and a substantially non-diffracting state depending on the eye/eye pupil position and, optionally, gaze direction. Typically, e.g. for a NED or a heads-up display, having a large eyebox is advantageous as it allows accommodating users with different interpupillary distance, and generally relaxes many requirements on the display and the positioning of the user's head relative to the display. Supporting a large eyebox however may require a large-area out-coupler, e.g. a large-area out-coupling (“output”) grating, only a portion of which is actually useful for any specific eye position within the eyebox. Adapting an active area of the out-coupler to the eye position, e.g. by switching off diffraction from the unused portion ore segments of the out-coupler, may enable increasing the lightguide throughput, and thus making the image brighter for the viewer, and may also reduce the appearance of some visual artifacts. In some embodiments, adjusting the diffraction efficiency in the useful portion of the out-coupler to the eye position, may enable a greater uniformity of the image across the FOV.

Accordingly, an aspect of the present disclosure provides a display apparatus comprising a lightguide for relaying image light to an eyebox, the lightguide comprising a substrate and an out-coupler integral with the substrate, and an eye detector configured to detect a position of an eye of a user in the eyebox. The out-coupler comprises a plurality of grating segments, each grating segment configured for diffracting at least a portion of the image light out of the substrate toward a corresponding portion of the eyebox, the grating segments being separately electrically tunable responsive to a control signal from the eye detector. The control signal may be indicative of the position of the eye pupil in the eyebox. The image light may carry an image in angular domain within an image field-of-view (FOV).

In some implementations, the grating segments are switchable between a diffracting state and a substantially non-diffracting state responsive to the control signal. In some implementations, the display apparatus may comprise a controller coupled to the out-coupler and the eye detector. The controller may be configured to switch to the substantially non-diffracting state those of the grating segments that are located outside of the image FOV from the eye pupil position in the eyebox. In some implementations the grating segments may have tunable diffraction efficiency in the diffracting state. The controller may be configured to selectively tune the diffraction efficiency of those of the grating segments that remain in the diffracting state. In some implementations at least one of the grating segments may have a grating pitch that is electrically tunable responsive to the control signal.

In some implementations, the plurality of grating segments comprises a liquid crystal layer between two transparent electrodes, wherein at least one of the transparent electrodes comprises a plurality of electrode segments. In some implementations, the plurality of grating segments comprises a fluidic grating.

In any of the above implementations, the display apparatus may further comprise an input coupler for coupling the image light into the substrate, the substrate comprising two opposing surfaces for guiding the image light within the substrate by total internal reflection (TIR) from the surfaces, the grating segments extending along the two surfaces.

In any of the above implementations, the display apparatus may further comprise a source of the image light.

An aspect of the present disclosure provides a method for displaying an image to a user, the method comprising: coupling image light into a lightguide having an output coupler adjacent a viewing area, the output coupler comprising a plurality of separately tunable grating segments, each grating segment operable to diffract at least a portion of the image light toward a corresponding segment of the viewing area; detecting a position of an eye pupil of the user in the viewing area; and tuning a first subset of the grating segments to a substantially non-diffracting state, the first subset being selected responsive to the position of the eye pupil.

In some implementations, the method is for displaying the image in an image FOV, and the first subset comprises the grating segments located outside of the image FOV when viewed from the position of the eye pupil. In some implementations the method comprises adjusting a diffraction efficiency of a second subset of the grating segments, the second subset comprising the grating segments located within the image FOV when viewed from the position of the eye pupil.

The method may include determining a change in the position of the eye pupil; responsive to the change, switching a grating segment from the first subset to a diffracting state, and switching another grating segment to the substantially non-diffracting state, the other grating segment being located within the image FOV for the position of the eye pupil before the change.

The tuning may include changing a voltage applied to the grating segments of the first subset to reduce an amplitude of a refractive index modulation therein for at least one polarization of incident light.

The method may include providing an electrical control signal to a voltage source coupled to the grating segments, the electrical control signal comprising information indicative of the position of the eye pupil, and changing a voltage applied to at least some of the segments depending on the electrical control signal.

An aspect of the present disclosure provides a display sub-assembly comprising a lightguide for relaying image light to an eyebox, the lightguide comprising: a substrate of optically transparent material comprising opposed outer surfaces for guiding the image light in the substrate by reflections therefrom, and an out-coupler disposed in or upon the substrate, the out-coupler configured to couple the image light out of the substrate toward the eyebox. The out-coupler comprises a plurality of independently electrically controlled grating segments disposed along the opposed surfaces, the segments being individually switchable between a diffracting state and a substantially non-diffracting state.

The display sub-assembly may comprise an eye detector configured to detect a position of an eye pupil of a user in the eyebox and operatively coupled to the out-coupler.

In some implementations, the plurality of grating segments comprises a liquid crystal layer between layers of electrically conducting optically transparent material, wherein at least one of the layers comprises a plurality of separate electrode segments. In some implementations the plurality of grating segments comprises a fluidic grating.

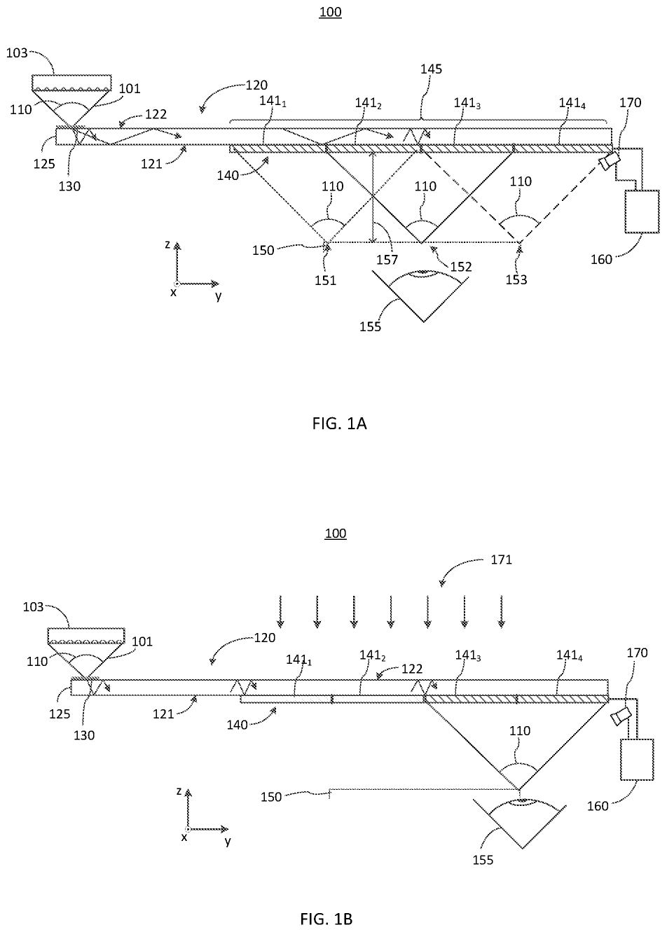

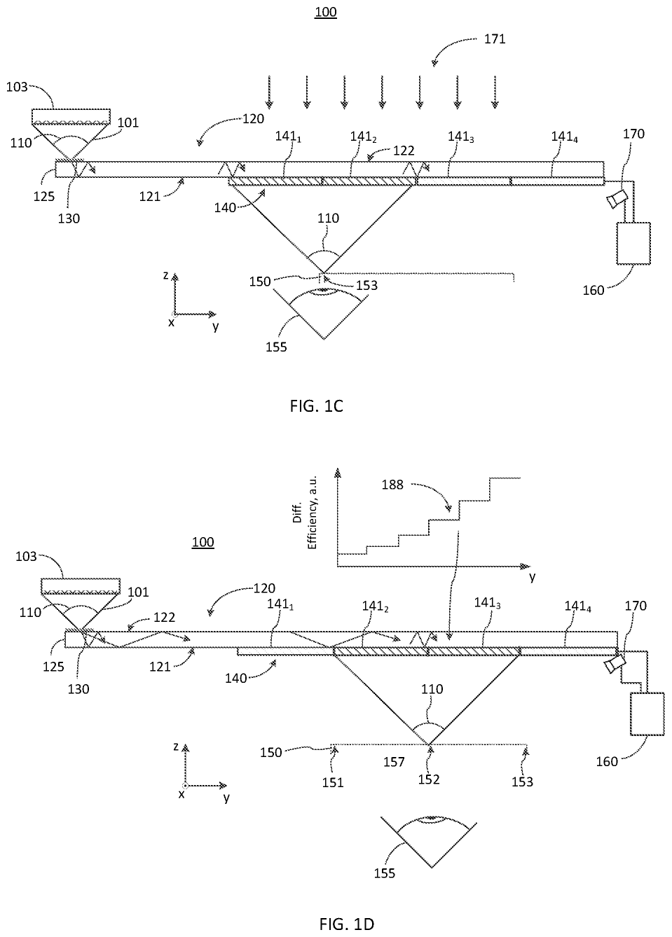

FIG. 1A illustrates an example display apparatus 100 for presenting images to a user. The display apparatus 100 may include an image projector 103 optically coupled to a lightguide 120. The image projector 103 is configured to provide image light 101 carrying the images in angular domain within a FOV 110 supported by the lightguide. The FOV 110 may also be referred to herein as the image FOV, and may represent a one-dimensional (1D) cross-section of a 2D FOV of the display apparatus 100. The lightguide 120 relays the image light 101 to an eyebox 150 of the display apparatus 100. The lightguide 120 includes a substrate 125, which may be e.g. a slab of a material that is transparent to visible light. The substrate 125 may also include one or more layers that are transparent to visible light. The substrate 125 has two opposing surfaces 121 and 122, e.g. the main outer surfaces of the substrate, and is configured for guiding the image light in the substrate in a zig-zag fashion by reflections from the surfaces 121 and 122. An out-coupler including an output diffraction grating (ODG) 140 is disposed in or upon the substrate 125 extending across an output region 145 thereof facing the eyebox 150. The ODG 140 is configured to diffract the substrate-propagating image light out of the substrate 125 toward the eyebox 150 at each incidence thereon, or at every other incidence depending on a position of the ODG 140 upon or within the substrate 125, thereby replicating the FOV 110 for various eye pupil locations within the eyebox 150 for viewing the images within the FOV 110 from any position of the eye 155 within the eyebox 150. Accordingly, the ODG 140 has an area along the surfaces 121, 122 that exceeds the area of the eyebox 150, with the area of the ODG 140 being the greater the bigger is the eyebox 150. For each location of the eye 155 within the eyebox 150, only a portion of the ODG 140 is visible to the eye 155 within the FOV 110; the image light diffracted from the rest of the ODG 140 does not reach the eye 155, and therefore may be de-activated.

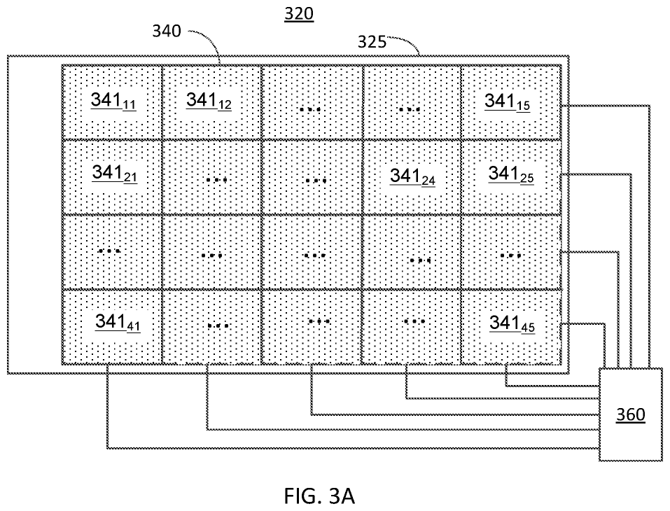

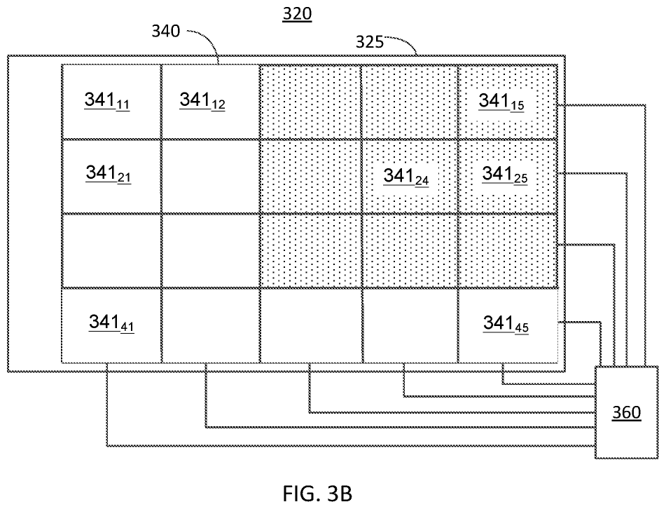

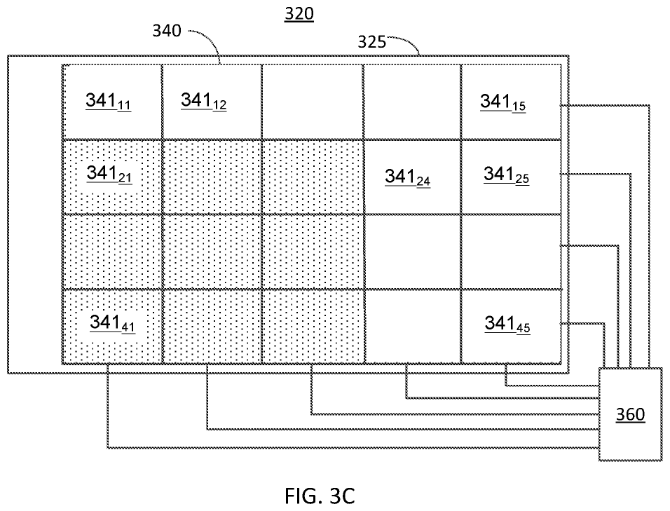

The ODG 140 includes a plurality of individually tunable grating segments 141ᵢ, i=1, . . . , N, which are disposed, e.g. tiled side by side, along the surfaces 121 and 122 to cover an output area of the substrate, e.g. as described below with reference to FIG. 3A. The individually tunable grating segments 141ᵢ may be generally referred to herein as segments 141. Here N is the number of grating segments; FIG. 1 shows four segments 141, i.e. grating segments 141₁, 141₂, 141₃, and 141₄ by way of example. More generally, the ODG 140 may include any number of segments 141 greater than one.

In some embodiments, at least some, e.g. two or more, of the segments 141 may be switchable between a diffracting state and a non-diffracting state. In some embodiments, each of the segments 141 may be switchable between a diffracting state and a substantially non-diffracting state. Switching a grating segment to a substantially non-diffracting state may be referred to herein as switching to an inactive state, “turning off”, or “deactivating”. Here “substantially” refers to a reduction in a diffraction efficiency of the segment, in an operating wavelength range of the lightguide, by at least a factor of 5 compared to a diffracting state of the segment. In some of these or other embodiments, the diffraction efficiency of at least some of the segments 141 may be individually continuously or quasi-continuously tunable, e.g. in a diffracting state of the segment, by an electrical signal applied to each segment 141. In some embodiments, the diffraction efficiency of each segment 141 of the ODG 140 may be continuously or quasi-continuously tunable by an electrical signal, e.g. voltage, applied to each segment 141. In some embodiments, at least some of the segments 141 of the ODG 140 may have a grating pitch that is electrically tunable responsive to an electrical control signal.

The display apparatus 100 further includes an eye detector 170 configured to detect the position of an eye 155 of a user in the eyebox 150, and a controller 160 operatively coupled to the eye detector 170 and the ODG 140 and configured to individually control the diffraction efficiency of segments 141 in dependence on a control signal from the eye detector 170. The eye detector 170 may include, for example, an eye-tracking camera for obtaining images of the eye 155 in the eyebox 150, and a processor for processing the images to determine the eye position within the eyebox 150. In some embodiments, the lightguide 120 may form a sub-assembly with the eye detector 170. In some embodiments, the eye detector 170 may be a part of an eye-tracking system which may further include an array of infrared illuminators (not shown) for illuminating the eyebox, with the eye detector 170 configured to obtain images of the eye 155 with reflections (glints) from the illuminators. In some embodiments the eye-tracking system my further include a hot mirror (not shown) for separating infrared and visible light. By detecting the position of glints and the position of the eye pupil, the eye position and orientation may be determined. In some embodiments, it may be sufficient to determine only the eye position, or the position of the eye pupil, in the eyebox 150.

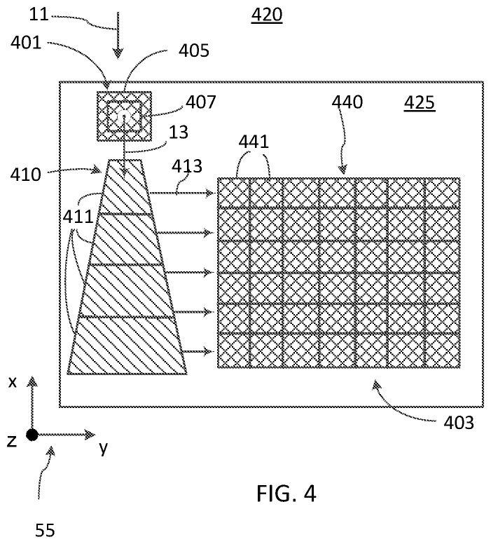

The image projector 103 may be embodied, for example, using a pixelated display panel, e.g. an LC micro display, optionally having suitable optics at its output. It may also be embodied using a light source, such as e.g. one or more light-emitting diodes (LED), superluminescent light-emitting diodes (SLED), side-emitting laser diodes, vertical-cavity surface-emitting laser diodes (VCSEL), etc., followed by an image beam scanner. The image light 101 provided by the projector 103 within the FOV 110 is coupled into the substrate 125 by an input optical coupler, such as e.g. an in-coupling (“input”) diffraction grating (IDG) 130 disposed in an input region of the lightguide as illustrated in FIG. 1A. In some embodiments, a coupling prism or other suitable coupling means may be used as an in-coupler. Is some embodiments, the IDG 130 may also be electrically tunable, e.g. have an electrically tunable pitch, and may be operable to adjust the FOV coupled into the substrate 125. In some embodiments, both the IDG 130 and the ODG 140 may be segmented, with the segments individually tunable by the controller 160. In some embodiments, only the ODG 140 may be segmented. In some embodiments, the substrate 125 may include a folding grating (not shown) disposed to receive in-coupled image light from the IDG 130 and to re-direct it toward the ODG 140. The folding grating may be configured to cooperate with the ODG 140 for 2D beam expansion and pupil replication, as described below with reference to FIG. 4.

As noted above, for each location of the eye 155 within the eyebox 150, only a portion of the ODG 140 is visible to the eye 155 within the FOV 110, with any portion of the image light that is diffracted from the rest of the ODG 140 not reaching the pupil of the eye 155. Accordingly, the controller 160 may be configured to deactivate, responsive to a control signal from the eye detector 170, those of the segments 141 of the ODG 140 that are positioned outside of the FOV 110 for the current eye position. By deactivating one or more of the segments 141 that do not contribute image light to the eye 155, the optical loss in the lightguide 120 may be lessened, and the throughput (output efficiency) of the lightguide improved, providing a brighter image. The size, along the surface of the substrate, of an active portion of the ODG 140 depends on the size of a region of the eyebox 250 where the pupil of the eye 155 is known to be located, the image FOV supported by the display, and a distance 157 between the ODG 140 and the eyebox 150.

FIGS. 1B-1D illustrate, by way of non-limiting illustrative examples, the operation of the display apparatus 100 of FIG. 1A when the pupil of the user's eye 155 is located at three different locations 151, 152, and 153 within the eyebox 150. Referring first to FIG. 1C, here the pupil of the user's eye 155 is located near the right-most edge of the eyebox 150, location 153 in FIG. 1A. In this position, segments 141₁ and 141₂ are outside of the FOV 110 currently visible to the user, and therefore do not contribute image light to the eye 155. Accordingly, the controller 160 may, responsive to a control signal from the eye detector 170 indicative of the current eye position, de-activate the segments 141₁ and 141₂, i.e. switch them to a substantially non-diffracting state, e.g. by suitably changing a voltage applied to the corresponding segments. In some embodiments, the controller 160 may also adjust the diffraction efficiency of the active segments 141₃ and 141₄ so that most of the in-coupled image light 101 propagating along the active segments 141₃ and 141₄ is diffracted toward the eyebox by the currently active segments 141₁ and 141₂. Advantageously, by de-activating the non-contributing segments 141₁ and 141₂, and by suitably adjusting the diffraction efficiency of the active segments 141₃ and 141₄, the useful throughput of the lightguide 120 may be increased, providing for a brighter image visible to the user. In embodiments adopted for AR applications, wherein the lightguide 120 is transparent to ambient light 171 carrying real-life scenery, switching the currently unused segments 141₁ and 141₂ of the output grating to a non-diffracting state may reduce undesirable grating-related artifacts, such as e.g. the rainbow artifact that may appear due to spurious diffractions of the ambient light 171 upon the grating structure.

FIG. 1C illustrates the display apparatus 100 of FIG. 1A when the pupil of the user's eye 155 is located near the left edge of the eyebox 150, i.e. at location 151 in FIG. 1A. In this position, segments 141₃ and 141₄ are outside of the FOV 110 visible to the user, and therefore do not contribute image light to the eye 155. Accordingly, the controller 160 may, responsive to a control signal from the eye detector 170 indicative of the current eye position, de-activate the segments 141₃ and 141₄, i.e. switch them to a substantially non-diffracting state, e.g. by suitably changing a voltage applied to the corresponding segments. In some embodiments, the controller 160 may also adjust the diffraction efficiency of the active segments 141₁ and 141₂ so that most of the in-coupled image light 101 propagating along the active segments 141₁ and 141₂ is diffracted toward the eyebox by the currently active segments 141₁ and 141₂. Here again, by de-activating the non-contributing segments 141₁ and 141₄, and by suitably adjusting the diffraction efficiency of the active segments 141₃ and 141₂, the useful throughput of the lightguide 120 may be increased, providing for a brighter image visible to the user.

FIG. 1D illustrates the display apparatus 100 of FIG. 1A when the pupil of the user's eye 155 is located near the center of the eyebox 150, location 152 in FIG. 1A. In this position, segments 141₁ and 141₄ are outside of the FOV 110 visible to the user, and therefore do not contribute image light to the eye 155. Accordingly, the controller 160 may, responsive to a control signal from the eye detector 170 indicative of the current eye position, de-activate the segments 141₁ and 141₄, i.e. switch them to a substantially non-diffracting state, e.g. by suitably changing a voltage applied to the corresponding segments. In some embodiments, the controller 160 may also adjust the diffraction efficiency of the active segments 141₃ and 141₂ so that most of the in-coupled image light 101 propagating along the active segments 141₃ and 141₂ is diffracted toward the eyebox by the currently active segments 141₃ and 141₂. By de-activating the non-contributing segments 141₁ and 141₄, and by suitably adjusting the diffraction efficiency of the active segments 141₃ and 141₂, the useful throughput of the lightguide 120 may be increased, providing for a brighter image visible to the user.

In some embodiments, e.g. where a currently active portion of the ODG 140 contains a suitably large number of individually tunable grating segments 141, those of the segments 141 that are active may be tuned to provide a desired spatial profile of the diffraction efficiency, e.g. in the direction of light propagation along the ODG 140 (y-axis), to facilitate a more uniform light output across the currently active portion of the ODG 140. For example, the diffraction efficiency of the segments may be set to rise with the distance from the in-coupler along the optical path of the image light, which corresponds to the y-axis in FIGS. 1A-1D. By way of non-limiting example, an insert in FIG. 1D illustrates a rising spatial profile of the diffraction efficiency across a currently active portion of the ODG 140 including a sequence of six grating segments in the y-axis direction. In this example embodiment, each of the grating segments 141₂ and 141₃ includes three independently tunable sub-segments or pixels.

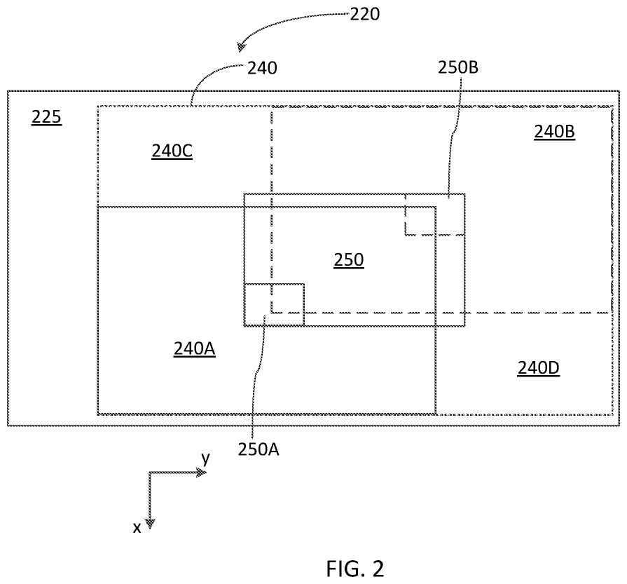

Referring to FIG. 2 for another non-limiting illustrative example, a pupil-replicating lightguide 220, shown in a plan view, includes a substrate 225, e.g. a slab of transparent material, for guiding image light in the slab by a series of internal reflections from outer surfaces of the substrate 225. The pupil-replicating lightguide 220 includes an ODG 240 adjacent to an eyebox 255, both shown in FIG. 2 in a top view in projection on an (x,y) plane parallel to the outer surfaces of the slab. The ODG 240 may be locally switchable, e.g. may be for example a segmented diffraction grating composed of a 2D array of grating segments that are individually switchable between a diffracting (“active”) state and a substantially non-diffractive (“inactive”) state. The pupil-replicating lightguide 220, the ODG 240, and the eyebox 255 may be embodiments of the lightguide 120, the ODG 140, and the eyebox 150 described above with reference to FIG. 1A.

An active area of the ODG 240 and, optionally, a spatial profile of the diffraction efficiency in the active area, may be adjusted based on a position of an eye of a user in the eyebox 255. By way of example, when the user's eye is located in a small region 250A of the eyebox 250, only a portion 240A of the ODG 240 is visible to the eye within the image FOV, and thus contributes into the visible image. When the user's eye is located in a small region 255B of the eyebox 255, only a portion 240B of the ODG 240 is visible to the eye within the image FOV, and thus contributes into the visible image. In FIG. 2, the eyebox region 250A and the corresponding portion 240A of the ODG 240 are outlined with dashed lines, while the eyebox region 250AB and the corresponding portion 240B of the ODG 240 are outlined with solid lines.

In some embodiments, the ODG 240 may be operated so that when an eye of the user is detected in the eyebox region 250A, the portion 240A of the ODG 240 is active, i.e. in a diffracting state wherein it diffracts image light propagating therethrough toward the eyebox region 250A of the eyebox 250, while the rest of the ODG 240, e.g. portions 240B, 240C, and 240D or at least parts thereof, may be inactive, i.e. in a substantially non-diffracting state. E.g. the ODG 240 may be segmented, and grating segments within the ODG portions 240B, 240C, and 240D may be switched to a substantially non-diffracting state. When an eye of the user is detected in the eyebox region 250B of the eyebox 250, the portion 240B of the grating is active and diffracts the image light propagating therethrough toward the eyebox region 250B, while the rest of the ODG 240, e.g. portions 240A, 240C, and 240D or at least parts thereof, may be inactive. For a segmented ODG 240, grating segments within the ODG portions 240B, 240C, and 240D may be switched to a substantially non-diffracting state.

In embodiments configured for AR applications, i.e. where the region of the lightguide 220 including the ODG 240 is see-through and combines image light carrying AR images with ambient light carrying real life scenery on the other side of the slab, switching at least a portion of the output grating to a substantially non-diffracting state may have an advantage of eliminating see-through artifacts such as the rainbow artifact, and to improve throughput for the ambient light being transmitted through the slab.

Furthermore, adapting the active area of an output grating of a lightguide to an eye position within the eyebox allows increasing output efficiency and therefore image brightness for an eyebox of a given size, increasing the size of the eyebox while maintaining the output efficiency of the lightguide, or some combination thereof. By suitably adjusting the spatial profile of the grating's diffraction efficiency across the output area of the ODG 240 to the smaller eyebox area, e.g. 250A or 250B, the image brightness visible to the user's eye from said are may be significantly increased.

In some embodiments, this adjustment includes deactivating portions of the ODG 240 that are outside of the image FOV when viewed from an eyebox area, e.g. 250A or 250B, where the user's eye and/or the eye pupil, is located, as described above. In some embodiments, the adjustment includes tuning the diffraction efficiency of the currently active portion of the ODG 240, e.g. so that most, if not all, in-coupled image light propagating through the ODG 240 is diffracted out of the waveguide within the currently active portion thereof. In some embodiments, e.g. when a currently active portion of the ODG 240 contains a suitably large number of individually tunable grating segments, the diffraction efficiency of the active segments may be tuned to facilitate a more uniform light output across the currently active portion of the ODG 240, e.g. in the direction of light propagation along the ODG 240. For example, the diffraction efficiency of the segments may be set to rise with the distance from the in-coupler along the optical path of the image light.

Referring now to FIG. 3A for a non-limiting illustrative example, a pupil-replicating lightguide 320, shown in a top plan view, includes a slab substrate 325 of transparent material for guiding light therein by a series of internal reflections from outer surfaces of the substrate 325. An electrically tunable/switchable grating 340 disposed in or upon the substrate 325 in an output region thereof includes a plurality of grating segments 341₁₁, 341₁₂, . . . , 341₄₅, which may be generally referred to as grating segments 341, and which characteristics are individually tunable, e.g. switchable from a diffracting state to a substantially non-diffracting state, by a controller 360. The pupil-replicating lightguide 320, the substrate 325, and the tunable/switchable grating 340 may be embodiments of the lightguide 120, the substrate 125, and the ODG 140, respectively, described above with reference to FIGS. 1A-1D, or embodiments of the lightguide 220, the substrate 225, and the ODG 240 described above with reference to FIG. 2. Although a 2D array of twenty segments 341 is shown, the number of segments 341 in the ODG 240 may be different, generally at least two. In various embodiments, the plurality of segments 341 may be disposed in a regular 2D array, an irregular 2D array, or along a single direction. By way of example, when the user's eye pupil is in the top right corner of the eyebox, e.g. in the eyebox region 250B illustrated in FIG. 2, the controller 360 may de-activate the grating segments 341 in the first and second columns and the fourth row of the segment array of grating 340, as illustrated in FIG. 3B by the non-patterned segments. When the user's eye pupil is in the bottom left corner of the eyebox, e.g. in the eyebox region 250A illustrated in FIG. 2, the controller 360 may de-activate the grating segments 341 in the fourth and fifths columns and the first row of the segment array of grating 340, as illustrated in FIG. 3C by the non-patterned segments.

Referring to FIG. 4, an example lightguide 420 is schematically shown in a plan view. The lightguide 420 is configured to expand, or replicate, an input image beam 11 along two different directions, e.g. along the x- and y-axes of the Cartesian coordinate system (x,y,z) 55 indicated in FIG. 4, although their orthogonality is not a requirement. The lightguide 420 includes a substrate 425 having a light input region 401, a light output region 403 including an out-coupler 440 that is offset from the input region along the two directions, and a folding grating 410. The beam 11, schematically shown with a solid arrow, is in-coupled into the substrate 425 by an input coupler 405 at an angle or angles exceeding a critical angle of TIR within the substrate 425, to cause the beam 11 propagate within the substrate 425 in a vertical zigzag pattern, bouncing off the outer surfaces thereof. Here, “vertical” relates to a plane or direction normal to the opposing outer surfaces of TIR in a lightguide substrate. Light of the input image beam 11 coupled into the substrate 425 may be referred to as the in-coupled light (beam). The portion of the beam 11 coupled into the substrate 425 and propagating therein by TIR may be referred to as the in-coupled beam 13 or the in-coupled light 13.

The input coupler 405 may be, for example, a diffraction grating or gratings extending across the input region 401 along one of the outer surfaces, or a prism coupler. In some embodiments the input coupler 405 may be 4 be selective with respect to the polarization of light incident thereon. The folding grating 410 is disposed to receive the in-coupled light 13 from the input coupler 405 and to re-direct it toward the output coupler 440 as laterally offset sub-beam 413. The output coupler 440 may be in the form of a segmented diffraction grating including a plurality of individually tunable grating segments 441, e.g. as described above with reference to FIGS. 3A-3C and grating segments 341. The folding grating 410 is configured to cooperate with the output coupler 440 for beam expansion and pupil replication along the x- and y-axes directions.

The input coupler 405 is configured to direct the in-coupled light beam 13 to propagate along the first direction in the plane of the substrate, e.g. along the x-axis, toward the folding grating 410. The folding grating 410 may be aligned with the input coupler 405 in the first direction, and is configured to re-direct the in-coupled light beam 13 to propagate along the second direction (y-axis) toward the output region 403. In the illustrated embodiment, the folding grating 410 may be a suitably configured diffraction grating or gratings having a length in the first direction (x-axis) sufficient to split the in-coupled light beam 13 into multiple laterally offset sub-beams 413, as illustrated in FIG. 4 by a sequence of parallel solid arrows.

In the illustrated embodiment, the folding grating 410 is segmented, including a sequence of grating segments 411 aligned along the general direction of propagation of the in-coupled light 13 (x-axis). Although four segments 411 is shown by way of example, either smaller or greater number of segments 411 may be present. Similar to the grating segments 441 of the output coupler 440, each of the grating segments 411 is switchable between a diffracting, or active, state, in which segment 411 diffracts a portion of the in-coupled beam 13 toward the output coupler 440, and an inactive state, i.e. substantially non-diffracting, which doesn't change the direction of propagation of the in-coupled beam 13. Responsive to a control signal from an eye detector (not shown), selected segments 411 of the folding grating 410 may be switched to the inactive state in coordination with switching selected grating segments 441 of the output coupler 440, with the segments selected depending on a position of the eye of the used in the eyebox. In some embodiments, the diffraction efficiency of those of the segments 411 that remain active may be adjusted so that substantially all, or most, of the in-coupled light beam energy is diffracted toward the output coupler 440 by the active segments 411.

Example embodiments described above include pupil-replicating lightguides incorporating one or more grating structures that have variable, e.g. switchable between two or more states or continuously tunable, diffraction efficiency. Some of such grating structures may have other tunable parameters, e.g. the grating pitch and/or the blazing angle that defines the orientation of the grating grooves, or fringes, relative to the input/output surfaces of the lightguide. Some of such switchable or tunable gratings include a material with electrically tunable refractive index, such as but not exclusively a liquid crystal (LC) medium.

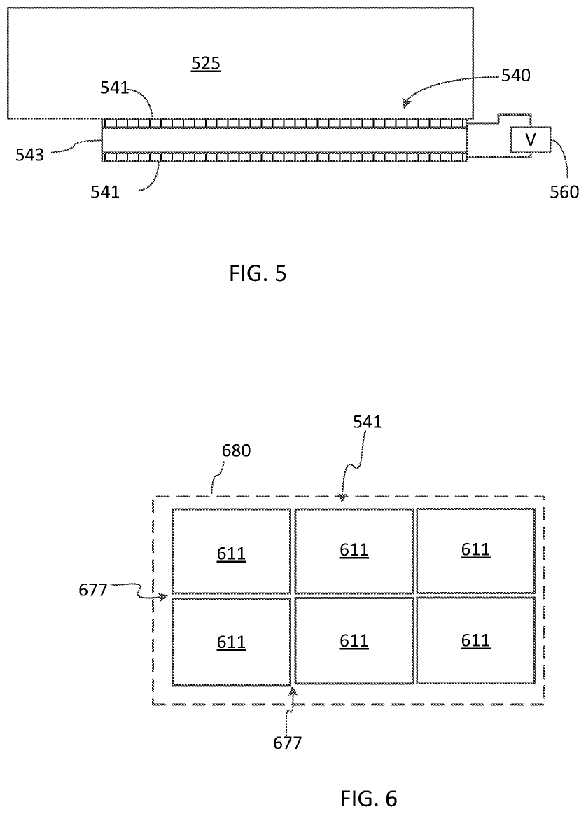

FIG. 5 illustrates an example of an electrically tunable diffraction grating 540, as may be used in embodiments described above. In the illustrated example, the electrically tunable diffraction grating 540 is in contact with an outer surface of a substrate 525 of a lightguide. In some embodiments the electrically tunable diffraction grating 540 may be incorporate within the substrate 525. The electrically tunable diffraction grating 540 includes a layer 543 sandwiched between electrodes 541 formed with an optically transparent material, e.g. a glass or plastic substrate coated with indium tin oxide (ITO), the layer having an electrically variable periodic refractive index modulation pattern. A controller 560, which includes a variable voltage source, is configured to vary at least one of the amplitude and the blazing angle of the refractive index modulation pattern, e.g. by varying a voltage applied to the electrodes 541.

Referring to FIG. 6, at least one of the electrodes 541 may be segmented, with a plurality of electrode segments 611 separated from each other by gaps 677. The electrode segments 611 may be formed, for example, by patterning an ITO layer disposed over, e.g., a glass or plastic substrate 680 that is transparent to visible light. Each of the electrode segments may be individually electrically connected to the controller 560. The controller 560 may be configured to individually vary voltages applied to the electrode segments 611. In example embodiments of the display systems described herein, the controller 560 may be configured to selectively vary voltages applied to the electrode segments 611 responsive to an electrical control signal from an eye detector, the electrical control signal being indicative of the position of an eye of a viewer.

In some embodiments, the material of layer 543 may contain LC medium, in which case the tunable diffraction grating 540 may be referred to as an LC grating. The LC medium may include e.g. nematic-type liquid crystals. Nematic liquid crystals may be composed of rod-like molecules that may have non-zero dipole moments and can be approximately aligned by an electrical filed. In another example, the liquid-crystal medium may include cholesteric liquid crystals, in which a molecular stack has a twisted, helical or heliconical structure. The liquid-crystal medium may also include any suitable mixture of nematic liquid crystals, which may have larger, better defined dipole moments and relatively high birefringence, and cholesteric-type liquid crystals, which may have smaller dipole moments but may have the advantage of responding more quickly to changing electric fields. For example, a layer of nematic liquid crystals may be doped with chiral dopants, which may increase the response time of the nematic liquid crystals. The application of an electric field, e.g., by applying a suitable voltage between the electrodes 541, may orient the dipole moments of LC molecules. For example, the application of an electric field to an LC layer, e.g. layer 543, may cause the formation of a molecular orientation pattern of the LC molecules, e.g., for nematic liquid crystals, or may modify an existing orientation pattern of the LC molecules, e.g., for cholesteric liquid crystals.

In some embodiments grating 540 may be an LC grating in which the period of the grating pattern is defined e.g. by pattering a photo-sensitive LC alignment layer, or by a surface relief pattern at an interface between the layer 543 and a substrate. In the case of tunable surface relief gratings (SRG), LC molecules between the surface relief groves have a different refractive index than the material of the groves. In the absence of the electric field the LC molecules are aligned horizontally, i.e. parallel to the substrate and along the groves, diffracting light polarized along the groves. A voltage applied across the LC layer may align the LC molecules along the electric filed direction, i.e. normally to the layer, thereby substantially eliminating the diffraction.

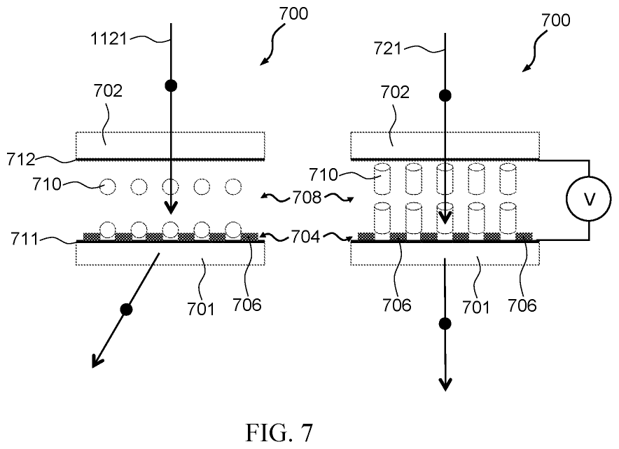

FIG. 7 illustrates a tunable LC SRG 700 that may be an embodiment of the electrically tunable diffraction grating 540. The tunable LC SRG 700 includes a first substrate 701 supporting a first conductive layer 711 and a surface-relief grating structure 704 having a plurality of ridges 706 extending from the first substrate 701 and/or the first conductive layer 711. A second substrate 702 is spaced apart from the first substrate 701. The second substrate 702 supports a second conductive layer 712. A cell is formed by the first 711 and second 712 conductive layers. The cell is filled with a LC fluid, forming an LC layer 708. The LC layer 708 includes nematic LC molecules 710, which may be oriented by an electric field across the LC layer 708. The electric field may be provided by applying a voltage V to the first 711 and second 712 conductive layers.

The surface-relief grating structure 704 may be polymer-based, e.g. it may be formed from a polymer having an isotropic refractive index nₚ of about 1.5, for example. The LC fluid has an anisotropic refractive index. For light polarization parallel to a director of the LC fluid, i.e. to the direction of orientation of the nematic LC molecules 710, the LC fluid has an extraordinary refractive index nₑ, which may be higher than an ordinary refractive index nₒ of the LC fluid for light polarization perpendicular to the director. For example, the extraordinary refractive index nₑ may be about 1.7, and the ordinary refractive index nₒ may be about 1.5, i.e. matched to the refractive index nₚ of the surface-relief grating structure 704.

When the voltage Vis not applied (left side of FIG. 7), the LC molecules 710 are aligned approximately parallel to the grooves of the surface-relief grating structure 704. At this configuration, a linearly polarized light beam 721 with e-vector oriented along the grooves of the surface-relief grating structure 704 will undergo diffraction, since the surface-relief grating structure 704 will have a non-zero refractive index contrast. When the voltage V is applied (right side of FIG. 7), the LC molecules 710 are aligned approximately perpendicular to the grooves of the surface-relief grating structure 704. At this configuration, a linearly polarized light beam 721 with e-vector oriented along the grooves of the surface-relief grating structure 704 will not undergo diffraction because the surface-relief grating structure 704 will appear to be index-matched and, accordingly, will have a substantially zero refractive index contrast. For the linearly polarized light beam 721 with e-vector oriented perpendicular to the grooves of the surface-relief grating structure 704, no diffraction will occur in either case (i.e. when the voltage is applied and when it is not) because at this polarization of the linearly polarized light beam 721, the surface-relief grating structure 704 are index-matched. Thus, the tunable LC surface-relief grating 700 can be switched on and off (for polarized light) by controlling the voltage across the LC layer 708. Several such gratings with differing pitch/slant angle/refractive index contrast may be used to switch between several grating configurations.

In some embodiments of the LC surface-relief grating 700, the surface-relief grating structure 704 may be formed from an anisotropic polymer with substantially the same or similar ordinary nₒ and extraordinary nₑ refractive indices as the LC fluid. When the LC director aligns with the optic axis of the birefringent polymer, the refractive index contrast is close to zero at any polarization of impinging light, and there is no diffraction. When the LC director is misaligned with the optic axis of the birefringent polymer e.g. due to application of an external electric field, the refractive index contrast is non-zero for any or most polarizations of the impinging light, and accordingly there is diffraction and beam deflection.

In some embodiments, the electrically tunable diffraction grating 540 may be a holographic polymer-dispersed liquid crystal (H-PDLC) grating that may be manufactured by causing interference between two coherent laser beams in layer 743, containing a photosensitive monomer/liquid crystal (LC) mixture, between the two substrates 741 having a conductive coating. Upon irradiation, a photoinitiator contained within the mixture initiates a free-radical reaction, causing the monomer to polymerize. As the polymer network grows, the mixture phase separates into polymer-rich and liquid-crystal rich regions. The refractive index modulation between the two phases causes light passing through the layer 743 to be scattered in the case of traditional PDLC2 or diffracted in the case of H-PDLC. When an electric field is applied across the cell, the index modulation is removed and light passing through the cell is unaffected. A description of such tunable diffraction gratings, which may be switched on and off, is provided in an article entitled “Electrically Switchable Bragg Gratings from Liquid Crystal/Polymer Composites” by Pogue et al., Applied Spectroscopy, v. 54 No. 1, 2000, which is incorporated herein by reference in its entirety.

In some embodiments, the electrically tunable diffraction grating 540 may be a polarization volume hologram (PVH) and/or a Pancharatnam-Berry phase (PBP) liquid crystal (LC) grating. Such gratings may be controlled either directly by applying an electric field to the LC layer, or indirectly by providing a serially coupled half-wave plate (HWP). When the electric field is applied to the LC layer, LC molecules are aligned in the electric field, changing effective refractive index, depending on polarization state of the impinging light.

In some embodiments, the layer 543 of the electrically tunable diffraction grating 540 may include a flexoelectric LC. LC molecules typically are electrical dipoles having a non-zero dipole moment, which usually do not exhibit spontaneous polarization because of equal probability for the dipoles to point to two opposite directions respectively, but become polarized in an external electric field. However LC molecules that do not have a perfect rod-shaped structure, but have e.g. a bend-shaped or a pear-shaped structure, may exhibit spontaneous polarization, termed flexoelectric polarization or flexoelectric effect. In materials with a low dielectric anisotropy and a non-zero flexoelectric coefficient difference (e1−e3), where e1 and e3 are the splay and bent flexoelectric coefficients, respectively, electric fields exceeding certain threshold values may result in a transition from the homogeneous planar state to a spatially periodic one, producing a diffraction grating in the layer 543. The field-induced grating is characterized by rotation of the LC director about the alignment axis in the alignment layer(s) adjacent the layer 543, with the wavevector of the grating oriented perpendicular to the initial alignment direction. The rotation sign is defined by both the electric field vector and the sign of the (e1−e3) difference. The wavenumber characterizing the field-induced periodicity is increased linearly with the applied voltage starting from a threshold value of about it/d, where d is the thickness of the layer. Examples of suitable flexoelectric LC materials, and of LC gratings incorporating such materials that may be used in embodiments of the present disclosure, are described in e.g. in an article entitled “Dynamic and Photonic Properties of Field-Induced Gratings in Flexoelectric LC Layers” by Palto in Crystals 2021, 11, 894, and a U.S. Pat. No. 10,890,823 assigned to the assignee of the present application, both which being incorporated herein by reference in its entirety.

In some embodiments, layer 543 of the electrically tunable diffraction grating 540 having a variable diffraction efficiency, grating period, or a slant angle may include helical and helicoidal LC. Cholesteric LCs (CLC), which have intrinsic periodicity in the form of the helical supramolecular structure, may be obtained e.g. by doping the nematic LC matrix with chiral components. The LC molecules in the mixture may self-organize into a periodic helically twisted configuration including helical structures extending between the top and bottom surfaces of the LC layer 543. Depending on a type of alignment conditions at the layer surfaces, the helical twist axes of the helical structures may be normal to the surfaces or tilt. The helical structures may form a volume grating that acts as a Bragg grating with the Bragg period equal to one half of the distance P, termed cholesteric pitch, along the helical axis where the LC director and the optic axis rotate by 360°. By varying the applied electrical field, the cholesteric pitch P and thus the Bragg period P/2 of the LC grating may be varied. In some embodiments of LC grating, e.g. some of those including a planar-aligned CLC layer, a diffractive pattern may appear when the applied electric field exceeds a threshold, and may vary in amplitude with the applied field, thereby enabling tuning the diffraction efficiency. In some embodiments a tunable LC grating may include oblique helicoidal LCs, in which the LC director is tilted at an oblique angle to the helical axis. Such LC gratings may have superior tunability because the applied electric field may tune the oblique angles and the pitch lengths in a relatively wide range without disturbing the helical axis orientation. Tunable gratings with oblique helicoidal LCs have been described e.g. in an article entitled “Electrooptic Response of Chiral Nematic Liquid Crystals with Oblique Helicoidal Director” by Xiang et al. Phys. Rev. Lett. 112, 217801, 2014, which is incorporated herein by reference in its entirety.

In at least some embodiments, an LC-based grating 540 such as those described above may be polarization selective. Such gratings may selectively diffract a light beam having a first polarization, e.g. linear or circular, but transmit a light beam having a second, typically orthogonal, polarization with negligible diffraction. In such embodiments, the display apparatuses described above may operate with polarized image light, e.g. to enhance the display's efficiency, and/or may include various polarizers and polarization converters, such as e.g. quarter-wave plates (QWP), half-wave plates (HWP), a-plates, and lightguides incorporating the same.

Tunable diffraction gratings other than LC grating may also be used in the example embodiments described above. In some embodiments, switchable/tunable gratings may be formed on a surface of the lightguide by providing a surface acoustic wave as disclosed e.g. in an article entitled “Status of Leaky Mode Holography” by Smalley et al., Photonics 2021, 8, 29, 2 which is incorporated herein by reference in its entirety. Such diffraction gratings may be tunable in both the grating pitch, by tuning the frequency of the acoustic wave, and the diffraction efficiency, by tuning its amplitude.

Diffraction gratings with a tunable/switchable diffraction efficiency may also be implemented as fluidic gratings. A fluidic grating may include two immiscible fluid layers, like water and oil, whose interface deforms when a spatially inhomogeneous electric field is applied. The spatially inhomogeneous electric field may be provided e.g. by using spatially inhomogeneous and/or discrete electrodes.

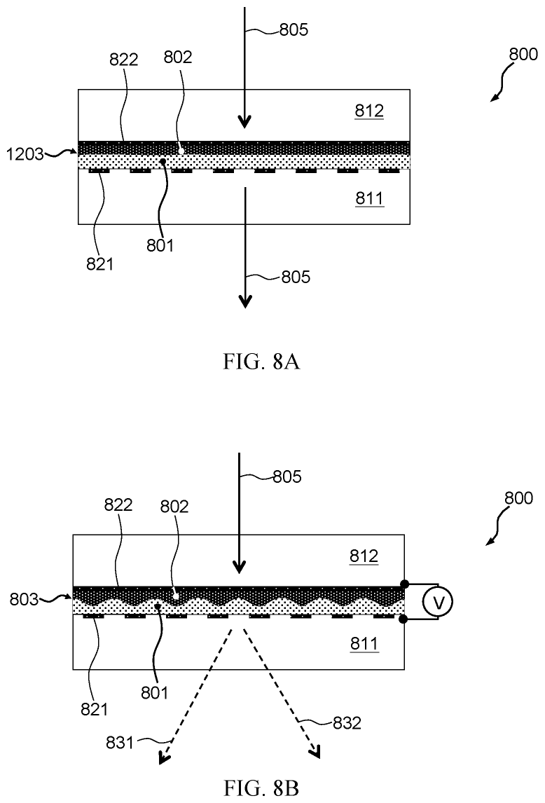

Referring to FIGS. 8A and 8B, a fluidic grating 1200 includes first 801 and second 802 immiscible fluids separated by an inter-fluid boundary 803. One of the fluids may be a hydrophobic fluid such as oil, e.g. silicone oil, while the other fluid may be water-based. One of the first 801 and second 802 fluids may be a gas in some embodiments. The first 801 and second 802 fluids may be contained in a cell formed by first 811 and second 812 substrates supporting first 821 and second 822 electrode structures. The first 821 and/or second 822 electrode structures may be at least partially transparent, absorptive, and/or reflective.

At least one of the first 821 and second 822 electrode structures may be patterned for imposing a spatially variant electric field onto the 801 and second 802 fluids. For example, in 8A and 8B, the first electrode 821 is patterned, and the second electrodes 822 is not patterned, i.e. the second electrodes 822 is a backplane electrode. In the embodiment shown, both the first 821 and second 822 electrodes are substantially transparent. For example, the first 821 and second 822 electrodes may be indium tin oxide (ITO) electrodes.

FIG. 8A shows the fluidic grating 800 in a non-driven state when no electric field is applied across the inter-fluid boundary 803. When no electric field is present, the inter-fluid boundary 803 is straight and smooth; accordingly, a light beam 805 impinging onto the fluidic grating 800 does not diffract, propagating right through as illustrated. FIG. 8B shows the fluidic grating 800 in a driven state when a voltage V is applied between the first 821 and second 822 electrodes, producing a spatially variant electric field across the first 801 and second 802 fluids separated by the inter-fluid boundary 803.

The application of the spatially variant electric field causes the inter-fluid boundary 803 to distort as illustrated in FIG. 8B, forming a periodic variation of effective refractive index, i.e. a surface-relief diffraction grating. The light beam 805 impinging onto the fluidic grating 800 will diffract, forming first 831 and second 832 diffracted sub-beams. By varying the amplitude of the applied voltage V, the strength of the fluidic grating 800 may be varied. By applying different patterns of the electric field e.g. with individually addressable sub-electrodes or pixels of the first electrode 821, the grating period and, accordingly, the diffraction angle, may be varied. More generally, varying the effective voltage between separate sub-electrodes or pixels of the first electrode 821 may result in a three-dimensional conformal change of the fluidic interface i.e. the inter-fluid boundary 803 inside the fluidic volume to impart a desired optical response to the fluidic grating 800. The applied voltage pattern may be pre-biased to compensate or offset gravity effects, i.e. gravity-caused distortions of the inter-fluid boundary 803.

Portions of a patterned electrode may be individually addressable. In some embodiments, the first electrode 821 may be replaced with a continuous, non-patterned electrode coupled to a patterned dielectric layer for creating a spatially non-uniform electric field across the first 801 and second 802 fluids. Also in some embodiments, the backplane electrode is omitted, and the voltage is applied between the segmented electrodes themselves.

The thickness of the first 821 and second 822 electrodes may be e.g. between 10 nm and 50 nm. The materials of the first 821 and second 822 electrodes besides ITO may be e.g. indium zinc oxide (IZO), zinc oxide (ZO), indium oxide (TO), tin oxide (TO), indium gallium zinc oxide (IGZO), etc. The first 801 and second 802 fluids may have a refractive index difference of at least 0.1, and may be as high as 0.2 and higher. One of the first 801 or second 802 fluids may include polyphenylether, 1,3-bis(phenylthio)benzene, etc. The first 811 and/or second 812 substrates may include e.g. fused silica, quartz, sapphire, etc. The first 811 and/or second 812 substrates may be straight or curved, and may include vias and other electrical interconnects. The applied voltage may be varied in amplitude and/or duty cycle when applied at a frequency of between 100 Hz and 100 kHz. The applied voltage can change polarity and/or be bipolar. Individual first 801 and/or second 802 fluid layers may have a thickness of between 0.5-5 micrometers, more preferably between 0.5-2 micrometer.

To separate the first 801 and second 802 fluids, surfactants containing one hydrophilic end functional group and one hydrophobic end functional group may be used. The examples of a hydrophilic end functional group are hydroxyl, carboxyl, carbonyl, amino, phosphate, sulfhydryl. The hydrophilic functional groups may also be anionic groups such as sulfate, sulfonate, carboxylates, phosphates, for example. Non-limiting examples of a hydrophobic end functional group are aliphatic groups, aromatic groups, fluorinated groups. For example, when polyphenyl thioether and fluorinated fluid may be selected as a fluid pair, a surfactant containing aromatic end group and fluronirated end group may be used. When phenyl silicone oil and water are selected as the fluid pair, a surfactant containing aromatic end group and hydroxyl (or amino, or ionic) end group may be used. These are only non-limiting examples.

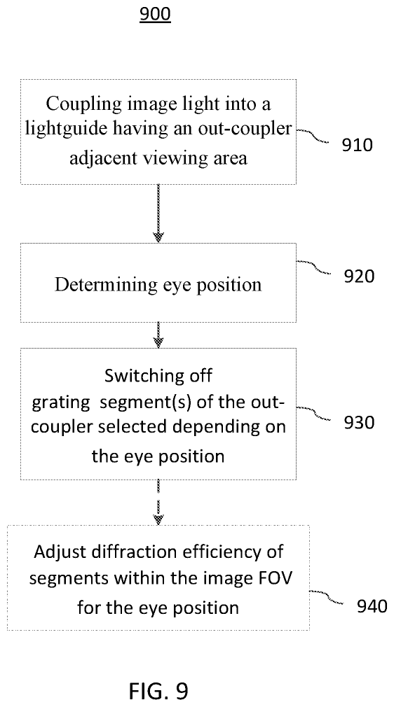

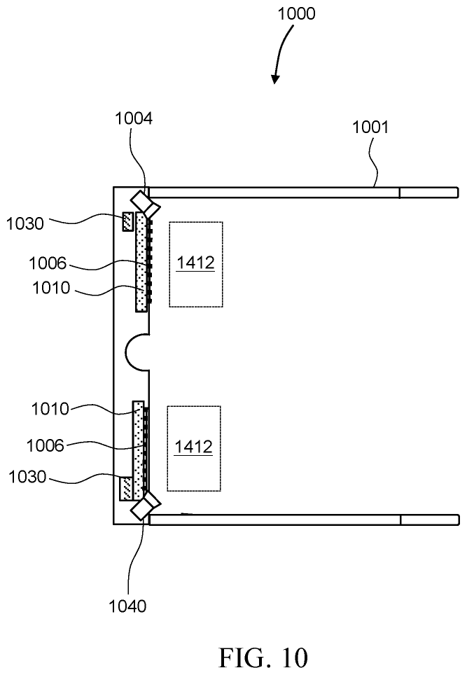

Referring to FIG. 9, example display systems described above may implement a method 900 for displaying an image to a user that includes the following steps or operations: (910) coupling image light into a lightguide having an output coupler adjacent a viewing area, the output coupler comprising a plurality of separately tunable grating segments, each grating segment operable to diffract at least a portion of the image light toward a corresponding segment of the viewing area; (920) detecting a position of an eye of the user in the viewing area; and (930) tuning a first subset of the grating segments to a substantially non-diffracting state, the first subset being selected responsive to the eye position. The switching may include changing a voltage applied to the at least a first one of the grating segments to reduce an amplitude of a grating structure therein.

In some embodiments, the method may include displaying the image within an image FOV, and step or operation 930 may include selecting, for the first subset of the grating segments, those of the grating segments located outside of the image FOV when viewed from the detected position of the eye. In some embodiments, the method may include (940) adjusting the diffraction efficiency of grating segments from a second subset of the grating segments, the second subset being in a diffracting state. In some embodiments, the grating segments from the second subset may be located at least in part within the image FOV when viewed from the detected position of the eye.

In some embodiments, the method may include: determining a change in the position of the eye; and, responsive to the change, switching at least one segment from the first set to a diffracting state, and switching at least one other of the grating segments from the diffracting state to the substantially non-diffracting state. In some embodiments, the method may include providing an electrical control signal to the out-coupler, the electrical control signal comprising information indicative of the position of the eye, and changing a voltage applied to the at least one of the segments depending on the electrical control signal.

Example embodiments described above have been described by way of example to assist in better understanding of salient features of their operation, and are capable of many variations and modifications. For example in some cases the example embodiments described above may be effective for monochromatic image light. For color images, the image light of different colors may be spatially and/or temporally multiplexed. In some embodiments, two or more stacked lightguides may be used to guide different color channels. In some embodiments, the grating pitch of the input and output couplers of the same lightguide may be tuned to accommodate different color channels in a time multiplexed manner. In at least some embodiments, more than one diffraction grating may be used to couple light out of the lightguide. Some embodiments may utilize more than one input diffraction grating and/or more than one output diffraction gratings, e.g. to support a 2D FOV. When two or more diffraction gratings are used for the in-coupling or the out-coupling, the gratings may be superimposed to form a 2D grating structure, e.g. at a same outer surface of the lightguide's substrate. In other embodiments, different in-coupling gratings or different out-coupling gratings may be disposed at the opposite outer surfaces of the substrate. Embodiments in which one or more input gratings or one or more output gratings are disposed in the bulk of the substrate are also within the scope of the present disclosure. In embodiments where the image light may get diffracted by N≥2 diffraction gratings with grating vectors kᵢ, i=1, . . . , N in succession, the grating periods may be adjusted so that the grating vectors kᵢ, i=1, . . . , N, sum to zero, i.e.

Σ₁^{N}kᵢ=0. (1)

In some embodiments, the grating periods of two or more of the diffraction gratings may be adjusted, e.g. when a change in the location of the eye of a user is detected, so that equation (1) holds.

Embodiments of the present disclosure may include, or be implemented in conjunction with, an artificial reality system. An artificial reality system adjusts sensory information about outside world obtained through the senses such as visual information, audio, touch (somatosensation) information, acceleration, balance, etc., in some manner before presentation to a user. By way of non-limiting examples, artificial reality may include virtual reality (VR), augmented reality (AR), mixed reality (MR), hybrid reality, or some combination and/or derivatives thereof. Artificial reality content may include entirely generated content or generated content combined with captured (e.g., real-world) content. The artificial reality content may include video, audio, somatic or haptic feedback, or some combination thereof. Any of this content may be presented in a single channel or in multiple channels, such as in a stereo video that produces a three-dimensional effect to the viewer. Furthermore, in some embodiments, artificial reality may also be associated with applications, products, accessories, services, or some combination thereof, that are used to, for example, create content in artificial reality and/or are otherwise used in (e.g., perform activities in) artificial reality. The artificial reality system that provides the artificial reality content may be implemented on various platforms, including a wearable display such as an HMD connected to a host computer system, a standalone HMD, a near-eye display having a form factor of eyeglasses, a mobile device or computing system, or any other hardware platform capable of providing artificial reality content to one or more viewers.

Referring to FIG. 10, a virtual reality (VR) near-eye display (NED) 1000 includes a frame 1001 supporting, for each eye: an image projector 1030, e.g. an LC display panel or a scanning projector; a lightguide 1010 including one or more segmented switchable gratings, e.g. as described above, for relaying image light generated by the image projector 1030 to a dynamically variable location in the eyebox 1012 where the eye is detected. A plurality of eyebox illuminators 1006, shown as black dots, may be placed around the lightguide 1010 on a surface that faces the eyebox 1012. An eye-tracking camera 1004 may be provided for each eyebox 1012.

The purpose of the eye-tracking cameras 1004 is to determine position and/or orientation of both eyes of the user. The eyebox illuminators 1006 illuminate the eyes at the corresponding eyeboxes 1012, allowing the eye-tracking cameras 1004 to obtain the images of the eyes, as well as to provide reference reflections i.e. glints. The glints may function as reference points in the captured eye image, facilitating the eye gazing direction determination by determining position of the eye pupil images relative to the glints images. To avoid distracting the user with the light of the eyebox illuminators 1006, the latter may be made to emit light invisible to the user. For example, infrared light may be used to illuminate the eyeboxes 1012.

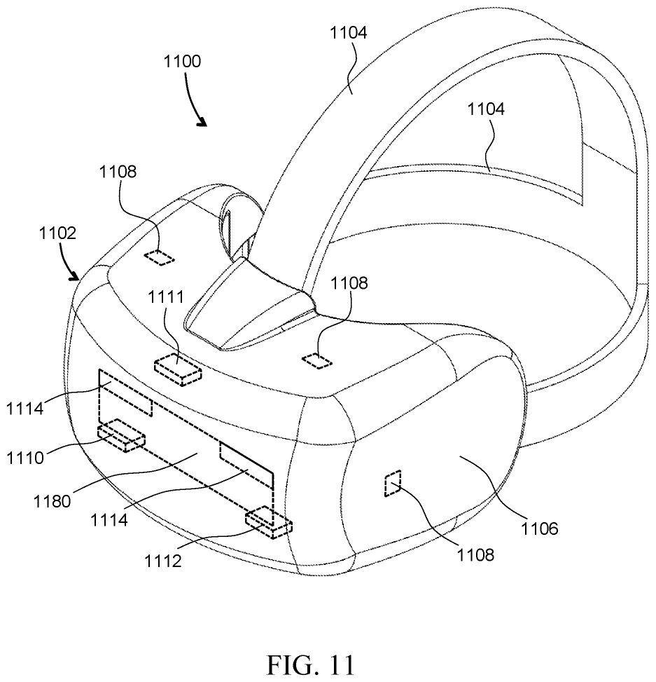

Turning to FIG. 11, an HMD 1100 is an example of an AR/VR wearable display system which encloses the user's face, for a greater degree of immersion into the AR/VR environment. The HMD 1100 may generate the entirely virtual 3D imagery. The HMD 1100 may include a front body 1102 and a band 1104 that can be secured around the user's head. The front body 1102 is configured for placement in front of eyes of a user in a reliable and comfortable manner. A display system 1180 may be disposed in the front body 1102 for presenting AR/VR imagery to the user. The display system 1180 may include any of the display devices, lightguides, and tunable segmented diffraction gratings disclosed herein. Sides 1106 of the front body 1102 may be opaque or transparent.

In some embodiments, the front body 1102 includes locators 1108 and an inertial measurement unit (IMU) 1110 for tracking acceleration of the HMD 1100, and position sensors 1112 for tracking position of the HMD 1100. The IMU 1110 is an electronic device that generates data indicating a position of the HMD 1100 based on measurement signals received from one or more of position sensors 1112, which generate one or more measurement signals in response to motion of the HMD 1100. Examples of position sensors 1112 include: one or more accelerometers, one or more gyroscopes, one or more magnetometers, another suitable type of sensor that detects motion, a type of sensor used for error correction of the IMU 1110, or some combination thereof. The position sensors 1112 may be located external to the IMU 1110, internal to the IMU 1110, or some combination thereof.

The locators 1108 are traced by an external imaging device of a virtual reality system, such that the virtual reality system can track the location and orientation of the entire HMD 1100. Information generated by the IMU 1110 and the position sensors 1112 may be compared with the position and orientation obtained by tracking the locators 1108, for improved tracking accuracy of position and orientation of the HMD 1100. Accurate position and orientation is important for presenting appropriate virtual scenery to the user as the latter moves and turns in 3D space.

The HMD 1100 may further include a depth camera assembly (DCA) 1111, which captures data describing depth information of a local area surrounding some or all of the HMD 1100. The depth information may be compared with the information from the IMU 1110, for better accuracy of determination of position and orientation of the HMD 1100 in 3D space.

The HMD 1100 may further include an eye tracking system 1114 for determining orientation and position of user's eyes in real time. The obtained position and orientation of the eyes also allows the HMD 1100 to determine the gaze direction of the user and to adjust the image generated by the display system 1180 accordingly. The determined gaze direction and vergence angle may be used to adjust the display system 1180 to reduce the vergence-accommodation conflict. The direction and vergence may also be used for displays' exit pupil steering as disclosed herein. Furthermore, the determined vergence and gaze angles may be used for interaction with the user, highlighting objects, bringing objects to the foreground, creating additional objects or pointers, etc. An audio system may also be provided including e.g. a set of small speakers built into the front body 1102.

The present disclosure is not to be limited in scope by the specific embodiments described herein. Indeed, other various embodiments and modifications, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A display apparatus comprising:
a lightguide comprising a substrate for relaying image light to an eyebox;
an eye detector configured to detect a position of an eye pupil of a user in the eyebox; and
an out-coupler disposed in or upon the substrate and comprising a plurality of grating segments, each grating segment configured for diffracting at least a portion of the image light out of the substrate toward a corresponding portion of the eyebox, the grating segments being separately electrically tunable responsive to a control signal from the eye detector.

2. The display apparatus of claim 1, comprising an input coupler for coupling the image light into the substrate, the lightguide comprising two opposing surfaces for guiding the image light within the substrate by total internal reflection (TIR) from the surfaces, wherein the grating segments extend along the two surfaces.

3. The display apparatus of claim 2, comprising a source of the image light.

4. The display apparatus of claim 1, wherein the grating segments are switchable between a diffracting state and a substantially non-diffracting state responsive to the control signal.

5. The display apparatus of claim 4, comprising a controller coupled to the out-coupler and the eye detector, wherein the image light carries an image in angular domain within an image field-of-view (FOV), wherein the control signal is indicative of the position of the eye pupil in the eyebox, and wherein the controller is configured to switch to the substantially non-diffracting state those of the grating segments that are located outside of the image FOV from the eye pupil position in the eyebox.

6. The display apparatus of claim 5, wherein the grating segments have tunable diffraction efficiency in the diffracting state.

7. The display apparatus of claim 6, wherein the controller is configured to selectively tune the diffraction efficiency of those of the grating segments that remain in the diffracting state.

8. The display apparatus of claim 1, wherein at least one of the grating segments have a grating pitch that is electrically tunable responsive to the control signal.

9. The display apparatus of claim 1, wherein the plurality of grating segments comprises a liquid crystal layer between two transparent electrodes, wherein at least one of the transparent electrodes comprises a plurality of electrode segments.

10. The display apparatus of claim 1, wherein the plurality of grating segments comprises a fluidic grating.

11. A method for displaying an image to a user, the method comprising:
coupling image light into a lightguide having an output coupler adjacent a viewing area, the output coupler comprising a plurality of separately tunable grating segments, each grating segment operable to diffract at least a portion of the image light toward a corresponding segment of the viewing area;
detecting a position of an eye pupil of the user in the viewing area; and
tuning a first subset of the grating segments to a substantially non-diffracting state, the first subset being selected responsive to the position of the eye pupil.

12. The method of claim 11 for displaying the image in an image field-of-view (FOV), wherein the first subset comprises the grating segments located outside of the image FOV when viewed from the position of the eye pupil.

13. The method of claim 12, comprising adjusting a diffraction efficiency of a second subset of the grating segments, the second subset comprising the grating segments located within the image FOV when viewed from the position of the eye pupil.

14. The method of claim 12 comprising:
determining a change in the position of the eye pupil;
responsive to the change,
switching a grating segment from the first subset to a diffracting state; and
switching another grating segment to the substantially non-diffracting state, the other grating segment being located within the image FOV for the position of the eye pupil before the change.

15. The method of claim 11, wherein the tuning comprises changing a voltage applied to the grating segments of the first subset to reduce an amplitude of a refractive index modulation therein for at least one polarization of incident light.

16. The method of claim 11 comprising:
providing an electrical control signal to a voltage source coupled to the grating segments, the electrical control signal comprising information indicative of the position of the eye pupil; and
changing a voltage applied to at least some of the segments depending on the electrical control signal.

17. A display sub-assembly comprising:
a lightguide for relaying image light to an eyebox, the lightguide comprising:
a substrate of optically transparent material comprising opposed outer surfaces for guiding the image light in the substrate by reflections therefrom; and
an out-coupler disposed in or upon the substrate, the out-coupler configured to couple the image light out of the substrate toward the eyebox, the out-coupler comprising a plurality of independently electrically controlled grating segments disposed along the opposed outer surfaces, the segments being individually switchable between a diffracting state and a substantially non-diffracting state.

18. The display sub-assembly of claim 17, comprising an eye detector configured to detect a position of an eye pupil of a user in the eyebox and operatively coupled to the out-coupler.

19. The display sub-assembly of claim 17, wherein the plurality of grating segments comprises a liquid crystal layer between layers of electrically conducting optically transparent material, wherein at least one of the layers comprises a plurality of separate electrode segments.

20. The display sub-assembly of claim 17, wherein the plurality of grating segments comprises a fluidic grating.
